(19) United States
(12) Patent Application Publication
(10) Pub. No.: US 2006/0054245 A1
(43) Pub. Date: Mar. 16, 2006

(54) Nanocomposite permanent magnets

(76) Inventors: Shiqiang Liu, Springboro, OH (US); Don Lee, Springboro, OH (US)

Correspondence Address: DINSMORE & SHOHL LLP, One Dayton Centre, Suite 1300, One South Main Street, Dayton, OH, 45402-2023, US

(21) Appl. No.: 11/024,590

(22) Filed: Dec. 29, 2004

Related U.S. Application Data
(60) Provisional application No. 60/533,674, filed on Dec. 31, 2003.

(51) Int. Cl. H01F 1/055

(52) U.S. Cl. 148/105; 148/302

(57) ABSTRACT

A nanocomposite, rare earth permanent magnet comprising at least two rare earth- or yttrium-transition metal compounds. The nanocomposite, rare earth permanent magnet can be used at operating temperatures of about 130 to about 300° C. and exhibits improved thermal stability when compared with Nd₂Fe₁₄B-based magnets. Methods of making the nanocomposite, rare earth permanent magnets are also shown.

### CROSS REFERENCE TO RELATED APPLICATIONS

This application claims the benefit of U.S. Provisional Application No. 60/533,674 filed Dec. 31, 2003.

### STATEMENT REGARDING FEDERALLY SPONSERED RESEARCH OR DEVELOPMENT

This invention was made with government support under Contract No. 03-S530-0030-01-C1 awarded by Air Force, Contract No. W911NF-04-1-0355 awarded by Army, and Grant No. DE-FG02-04ER86185 awarded by DoE. The government has certain rights in the invention.

### BACKGROUND OF THE INVENTION

The present invention relates generally to permanent magnets, and more particularly to nanocomposite permanent magnets having enhanced performance. These magnets may be used in various applications at operating temperatures of about 130 to about 300° C.

Permanent magnet materials have been widely used in a variety of applications for example, in motors, generators, sensors, and the like for automotive, aircraft, and spacecraft systems, among others. Currently, there are two major types of high performance permanent magnets in use. One type of magnet is based on Nd₂Fe₁₄B compounds, and the other is based on Sm₂Co₁₇ compounds. The Nd₂Fe₁₄B magnets exhibit excellent room temperature magnetic performance with (BH)ₘₐₓ up to over 50 MGOe. However, the Curie temperature of the Nd₂Fe₁₄B compound is only 312° C., which limits the highest operating temperature of an Nd₂Fe₁₄B magnet to about 80 to about 120° C.

In contrast, the Sm₂Co₁₇ magnets have excellent thermal stability because the Sm₂Co₁₇ compound has a very high Curie temperature of 920° C., almost triple that of the Nd₂Fe₁₄B compound. Commercial Sm₂(Co,Fe,Cu,Zr)₁₇ magnets can be reliably operated at 300° C. In recent years, researchers have shown that the highest operating temperature of sintered Sm₂(Co,Fe,Cu,Zr)₁₇ magnets can be increased to as high as 550° C.

There is a wide gap in the maximum operating temperatures between the Nd₂Fe₁₄B- and Sm₂(Co,Fe,Cu,Zr)₁₇-based magnets (about 120 to about 300° C.). This temperature range is important for use in automotive applications, sensors, and particle focusing devices. However, it is not economically feasible to use Sm₂(Co,Fe,Cu,Zr)₁₇-based magnets in this temperature range.

Efforts to increase the operating temperature of Nd₂Fe₁₄B-based magnets have proved difficult. Substituting Co for Fe in Nd₂Fe₁₄B can increase the Curie temperature and thus extend its operating temperature to about 120° C. However, Co substitution reduces coercivity and significantly increases the irreversible loss of Nd—Fe—B magnets.

Another approach is to partially substitute heavy rare earths, such as Dy and/or Tb, for Nd. Both Dy and Tb significantly enhance coercivity of Nd—Fe—B magnets, but they also decrease magnetization. In addition, Dy and Tb are very expensive.

Another proposed solution has been to synthesize a composite magnet including both Nd₂Fe₁₄B and Sm₂(Co,Fe,Cu,Zr)₁₇ compounds with micron-size grains. However, the process of making Nd₂Fe₁₄B magnets is significantly different from that of making Sm₂(Co,Fe,Cu,Zr)₁₇ magnets. The process of making sintered Nd₂Fe₁₄B is relatively simple and includes melting, crushing, milling, powder alignment and compaction, sintering at about 1080° C., followed by annealing at about 560° C. In contrast, the process for making Sm₂(Co,Fe,Cu,Zr)₁₇ magnets is quite complicated. After compaction, the green bodies are sintered at a temperature of at least about 1200° C. in order to reach full density. This sintering temperature is higher than the melting point of Nd₂Fe₁₄B. After sintering, a solid solution heat treatment at around 1180° C. for about 3 to 5 hrs followed by a rapid quench is required to obtain a uniform single phase alloy. The next step is long-term isothermal aging at about 800° C. In order to obtain high intrinsic coercivity, the aging time can be 50 hrs or more. However, even after this long-term aging, the coercivity obtained can be quite low (<2 kOe). The high intrinsic coercivity is developed during the very slow cooling (i.e., about 1 to 2° C. per minute) from about 800° C. to about 400° C. Aging at 400° C. can further improve coercivity.

The differences between the two processes make it difficult to find a process that can be used for both Nd₂Fe₁₄B and Sm₂(Co,Fe,Cu,Zr)₁₇.

Even if a single sintering or heat treatment procedure could be developed, it is still difficult to produce a high-performance composite magnet because interdiffusion between the Sm and Nd materials takes place at elevated temperatures. Most interdiffusion products, such as Nd₂(Co,Fe)₁₇, Sm₂Fe₁₄B, and Sm₂Fe₁₇, have basal-plane anisotropy, resulting in significantly reduced coercivity for the composite magnet.

Accordingly, there is a need for a magnet which can be easily produced, which exhibits thermal stability, and which may be used at operating temperatures of about 130 to about 300° C.

### SUMMARY OF THE INVENTION

The present invention meets that need by providing a new class of nanocomposite permanent magnets which can be used at operating temperatures between about 130 to about 300° C. and have good magnet properties.

The nanocomposite magnet of the present invention generally comprises at least two different components, each of which is based on a rare earth- or yttrium-transition metal compound. Each of the rare earth- or yttrium-transition metal compounds is specified in atomic percentage as RₓT_{100-x-y}M_{y}, and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20. The at least two rare earth- or yttrium-transition metal compounds are of different types, or contain different R, or both. The nanocomposite, rare earth permanent magnet has a structure selected from isotropic or anisotropic. The nanocomposite, rare earth permanent magnet has an average grain size in a range of about 1 nm to about 1000 nm. The nanocomposite, rare earth permanent magnet has a maximum operating temperature in a range of from about 130° C. to about 300° C. X is the effective rare earth (or yttrium) content. By “effective rare earth content,” we mean the metallic part of the total rare earth content.

Another aspect of the invention is a method of making the nanocomposite, rare earth permanent magnets. One method includes blending at least two powdered rare earth- or yttrium-transition metal alloys; and hot pressing the at least two powdered rare earth- or yttrium-transition metal alloys to form the nanocomposite, isotropic rare earth permanent magnet. The nanocomposite, isotropic rare earth permanent magnet can be hot deformed to form the nanocomposite, anisotropic rare earth permanent magnet.

An alternate method involves blending at least two powdered rare earth- or yttrium-transition metal alloys; pre-compacting the blended powdered rare earth- or yttrium-transition metal alloys at a temperature less than a crystallization temperature of a corresponding amorphous alloy to form a compact; and hot deforming the compact to form the nanocomposite, anisotropic rare earth permanent magnet.

Another alternate method involves blending at least two powdered rare earth- or yttrium-transition metal alloys; and hot deforming the blended powdered alloys in a container to form the nanocomposite, anisotropic rare earth permanent magnet.

### BRIEF DESCRIPTION OF THE DRAWINGS

FIG. 1 is a schematic illustration of methods of forming nanocomposite, rare earth permanent magnets in accordance with the present invention;

FIG. 2 is a graph illustrating maximum operating temperature vs. room temperature magnetic performance of nanocomposite Nd—Fe—B/R—Co magnets of the present invention compared with existing magnets;

FIG. 3 is a graph illustrating temperature coefficient of (BH)ₘₐₓ vs. temperature of nanocomposite Nd—Fe—B/R—Co magnets of the present invention compared with existing magnets;

FIG. 4 is a graph illustrating maximum energy product vs. temperature of a Nd—Fe—B/R—Co magnet compared with existing magnets;

FIG. 5 is a graph illustrating demagnetization curves of isotropic and anisotropic nanocomposite Nd₂Fe₁₄B/Sm₂(Co,Fe)₁₇ magnets;

FIG. 6 is a graph illustrating demagnetization curves of a hot deformed nanocomposite Nd₁₄Fe_{74.5}Co₅Ga_{0.5}B₆/Sm_{7.7}Co_{63.7}Fe_{28.6} [80 wt %/20% wt] magnet and a hot deformed conventional composite Nd₁₅Fe₇₉B₆/Sm(Co,Fe,Cu,Zr)_{7.4} [80 wt %/20% wt] magnet with micron grain structure;

FIG. 7 is a graph illustrating demagnetization curves of a conventional sintered anisotropic Nd₁₅Fe₇₉B₆/Sm(Co,Fe,Cu,Zr)_{7.4} [80 wt %/20% wt] and a conventional sintered anisotropic Nd₂Fe₁₄B/Sm₂(Co,Fe)₁₇ [80 wt %/20% wt] magnet;

FIG. 8 is a graph illustrating demagnetization curves of a nanocomposite Nd₁₄Fe_{74.5}Co₅Ga_{0.5}B₆/Sm_{7.7}Co_{63.7}Fe_{28.6} [80 wt %/20 wt %] magnet after hot press at 575° C. and after hot deformation at 850° C. with 50% height reduction;

FIG. 9 is a graph illustrating demagnetization curves of a nanocomposite Nd₁₄Fe_{74.5}Co₅Ga_{0.5}B₆/Sm_{7.7}Co_{63.7}Fe_{28.6} [80 wt %/20 wt %] magnet after hot press at 600° C. and after hot deformation at 850° C. with 40% height reduction;

FIG. 10 is a graph illustrating demagnetization curves of an anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 880° C. with 60% height reduction;

FIG. 11 is a graph illustrating demagnetization curves of an anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 920° C. with 60% height reduction; and

FIG. 12 is a graph illustrating demagnetization curves of an anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 880° C. with 60% height reduction.

FIG. 13 is a graph illustrating demagnetization curves of an anisotropic nanocomposite Pr₁₄Fe_{73.5}Co₅Ga_{0.5}B₇/Pr_{16.7}Co_{83.3} [80 wt %/20 wt %] magnet hot deformed at 940° C. with 71% height reduction.

FIG. 14 is a graph illustrating demagnetization curves of an anisotropic nanocomposite Pr₁₄Fe_{73.5}Co₅Ga_{0.5}B₇/Pr_{16.7}Co_{66.6}Fe_{16.7} [80 wt %/20 wt %] magnet hot deformed at 920° C. with 71% height reduction.

FIG. 15 is a graph showing temperature coefficients of magnetic flux v. temperature of nanograin Nd₁₄Fe_{74.5}Co₅Ga_{0.5}B₆, Sm_{7.7}Co_{63.7}Fe_{28.6} magnets and two nanocomposite Nd₁₄Fe_{74.5}Co₅Ga_{0.5}B₆/Sm_{7.7}Co_{63.7}Fe_{28.6} magnets.

FIG. 16 is a graph showing the temperature dependence of intrinsic coercivity of nanocomposite Nd₁₄Fe_{74.5}Co₅Ga_{0.5}B₆/Sm_{7.7}Co_{63.7}Fe_{28.6} [60 wt %/40 wt %] magnet.

FIG. 17 is a graph showing the low field magnetization v. temperature for a nanocomposite Nd₁₄Fe_{74.5}Co₅Ga_{0.5}B₆/Sm_{7.7}Co_{63.7}Fe_{28.6} [80 wt %/20 wt %] magnet.

FIG. 18 is an SEM micrograph of fracture surface of a hot deformed Nd₁₄Fe_{74.5}Co₅Ga_{0.5}B₆/Sm_{7.7}Co_{63.7}Fe_{28.6} [80 wt %/20 wt %].

FIG. 19 is a graph showing the results of a long-term aging experiment of a nanocomposite Nd₁₄Fe_{74.5}Co₅Ga_{0.5}B₆/Sm_{7.7}Co_{63.7}Fe_{28.6} [80 wt %/20 wt %] magnet.

FIG. 20 is a diagram showing a hot compaction (hot press) process.

FIG. 21 are diagrams showing various hot deformation processes.

### DETAILED DESCRIPTION OF THE INVENTION

The nanocomposite magnet of the present invention generally comprises at least two different components, each of which is based on a rare earth- or yttrium-transition metal compound. The composite magnets incorporate the advantages of different compounds. They may have enhanced performance, such as improved temperature coefficients of magnetic properties and higher operating temperatures. Each of the rare earth- or yttrium-transition metal compounds is specified in atomic percentage as RₓT_{100-x-y}M_{y}, and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20. The at least two rare earth- or yttrium-transition metal compounds are of different types, or contain different R, or both. The nanocomposite, rare earth permanent magnet has a structure selected from isotropic or anisotropic. The nanocomposite, rare earth permanent magnet has an average grain size in a range of about 1 nm to about 1000 nm. The nanocomposite, rare earth permanent magnet has a maximum operating temperature in a range of from about 130° C. to about 300° C.

The atomic ratio of R:T, or R:T:M is generally 1:5, 1:7, 2:17, 2:14:1, or 1:12. The compounds can have a type selected from RT₅, RT₇, R₂T₁₇, R₂T₁₄M, or RT₁₂.

The at least two rare earth- or yttrium-transition metal compounds are of different types, or have different rare earth or yttrium elements, or both. In the first case, the compounds are of different types but have the same rare earth (or yttrium), such as SmCo₅/SmCo₁₇, or Pr₂Fe₁₄B/PrCo₅.

In the second case, the compounds are of the same type but have different rare earths (or yttrium), for example, SmCo₅/PrCo₅, or Nd₂Fe₁₄B/Pr₂Fe₁₄B. However, this case is different from the situation in which uniform (Sm,Pr)Co₅ or (Nd,Pr)₂Fe₁₄B alloys are made. In the case of the uniform (Sm,Pr)Co₅ or (Nd,Pr)₂Fe₁₄B alloys, the rare earth sublattice is basically alternatively occupied by Sm and Pr (or Nd and Pr). In the present invention, SmCo₅ and PrCo₅ (or Nd₂Fe₁₄B and Pr₂Fe₁₄B) are two distinguished phases in a composite magnet. However, this does not exclude the situation in which a (Sm,Pr)Co₅ or (Nd,Pr)₂Fe₁₄B phase exists in a small localized region as a result of interdiffusion.

In the third situation, the compounds are of different types and have different rare earths (or yttrium), such as Nd₂Fe₁₄B/Sm₂Co₁₇.

A nanocomposite rare earth permanent magnet according to the present invention includes at least two rare earth- or yttrium-transition metal compounds, and they can be expressed in atomic percentage as (RₓT_{100-x-y}M_{y})₁/(RₓT_{100-x-y}M_{y})₂/ . . . /(RₓT_{100-x-y}M_{y})ₙ [a₁ wt %/a₂ wt %/ . . . /aₙ wt %] where an wt % is the weight percentage of the n component, and a₁ wt %+a₂ wt %+ . . . aₙ wt %=100%, where n is the number of rare earth- or yttrium-transition metal compounds and is equal to or greater than 2. For example, if a nanocomposite rare earth permanent magnet according to the present invention includes two rare earth- or yttrium-transition metal compounds, it can be expressed as (RₓT_{100-x-y}M_{y})₁/(RₓT_{100-x-y}M_{y})₂ [a₁ wt %/a₂ wt %] where a₁ wt % is the weight percentage of the first component and a₂ wt % is the weight percentage of the second component, and a₁ wt %+a₂ wt %=100%.

The composition of the 1:5 type compound is expressed as RₓT_{100-x-y}M_{y}where x is the effective rare earth (or yttrium) content and x is between about 3 to about 18, and y is between about 0 to about 20. When x=16.67 and y=0, the compound will be a single-phase RT₅ with a CaCu₅ type of hexagonal crystal structure. When x>16.67, there will be a rare earth-rich phase in the alloy, and when x<16.67, there will be a magnetically soft phase in the alloy.

The composition of the 1:7 compound is expressed as RₓT_{100-x-y}M_{y} where x is the effective rare earth (or yttrium) content and x is between about 3 to about 14, and y is between about 0 to about 20. When x=12.5 and y=0, the compound will be a single-phase RT₇ with a TbCu₇ type of hexagonal crystal structure. When x>12.5 there will be a rare earth-rich phase in the alloy, and when x<12.5 there will be a magnetically soft phase in the alloy.

The composition of the 2:17 compound is expressed as RₓT_{100-x-y}M_{y} where x is the effective rare earth (or yttrium) content and x is between about 3 to about 12, and y is between about 0 to about 20. When x=10.53 and y=0, the compound will be a single-phase R₂T₁₇ with a Th₂Zn₁₇ type of rhombohedral crystal structure or a Th₂Ni₁₇ type of hexagonal crystal structure. When x>10.53 there will be a rare earth-rich phase in the alloy, and when x<10.53 there will be a magnetically soft phase in the alloy.

The composition of the 2:14:1 compound is expressed as RₓT_{100-x-y}M_{y} where x is the effective rare earth (or yttrium) content and x is between about 3 to about 15, and y is between about 1 to about 20. When x=11.76, and y=5.88, the compound will be a single-phase Nd₂Fe₁₄B with a tetragonal crystal structure. When x>11.76 there will be a rare earth-rich phase in the alloy, and when x<11.76 there will be a magnetically soft phase in the alloy.

The composition of the 1:12 compound is expressed as RₓT_{100-x-y}M_{y} where x is the effective rare earth (or yttrium) content and x is between about 3 to about 9, and y is between about 0 to about 20. When x=7.69 and y=0, the compound will be a single-phase RT₁₂ with a ThMn₁₂ type of tetragonal crystal structure. When x>7.69 there will be a rare earth-rich phase in the alloy, and when x<7.69 there will be a magnetically soft phase in the alloy.

Suitable rare earths include, but are not limited to, Nd, Sm, Pr, Dy, La, Ce, Gd, Tb, Ho, Er, Eu, Tm, Yb, Lu, MM (MM is misch metal, which is a mixture of rare earths), and combinations thereof. Suitable transition metals include, but are not limited to, Fe, Co, Ni, Ti, Zr, Hf, V, Nb, Ta, Cr, Mo, W, Mn, Cu, Zn, and Cd. Suitable elements for M include, but are not limited to, B, Al, Ga, In, Ti, C, Si, Ge, Sn, Sb, and Bi.

The nanocomposite magnet of the present invention has a nanograin structure, i.e., the average grain size of each compound in the composite magnet is in the nanometer range. The average grain size of the resulting nanocomposite magnets generally ranges from about 1 nm to about 1000 nm.

While not wishing to be bound by any theory, it is believed that the coercivity of the nanocomposite magnet of the present invention is directly controlled by magneto-crystalline anisotropy. Accordingly, high coercivity may be readily obtained in such magnets. Thus, non-ferromagnetic elements, such as Cu or Zr, do not need to be added to Sm₂(Co,Fe)₁₇. For the same reasons, the long-term aging and very slow cooling are no longer required for developing high coercivity in Sm₂(Co,Fe)₁₇ type of magnets. Thus, the processes of making Nd₂Fe₁₄B- and Sm₂(Co,Fe)₁₇-magnets are compatible. In addition, very short processing time at elevated temperature can minimize any interdiffusion at elevated temperatures.

In order to further avoid interdiffusion between compounds containing different rare earths or yttrium, such as Nd₂Fe₁₄B and Sm₂(Co,Fe)₁₇, alternative nanocomposite magnets containing the same rare earth (or yttrium) and similar transition metals in different compounds, such as Pr₂(Fe,Co)₁₄B/Pr(Co,Fe)₅, Pr₂(Fe,Co)₁₄B/Pr₂(Co,Fe)₁₇, Y₂(Fe,Co)₁₄B/Y(Co,Fe)₅, MM₂(Fe,Co)₁₄B/MM(Co,Fe)₅, can be synthesized. Interdiffusion can be basically avoided in these systems.

Therefore, all of the technical difficulties associated with making conventional composite Nd₂Fe₁₄B/Sm₂(Co,Fe,Cu,Zr)₁₇ magnets can be readily overcome by the methods of the present invention.

Nanocomposites which may be produced in accordance with the method of the present invention include, but are not limited to, the following examples:

Case 1: The nanocomposite magnets contain different compound types with the same rare earths (or yttrium), such as SmCo₅/Sm₂Co₁₇; Pr₂Fe₁₄B/PrCo₅; Pr₂Fe₁₄B/Pr(Co,Fe)₅; Pr₂Fe₁₄B/Pr₂(Co,Fe)₁₇; Ce₂Fe₁₄B/CeCo₅; Ce₂Fe₁₄B/Ce₂(Co,Fe)₁₇; Y₂Fe₁₄B/YCo₅; Y₂Fe₁₄B/Y₂(Co,Fe)₁₇; La₂Fe₁₄B/LaCo₅; MM₂Fe₄B/MMCo₅; MM₂Fe₁₄B/MM₂(Co,Fe)₁₇.

Case 2: The nanocomposite magnets contain the same compound type but with different rare earths (or yttrium), such as SmCo₅/PrCo₅; PrCo₅/CeCo₅; CeCo₅/MMCo₅.

Case 3: The nanocomposite magnets contain different compound types and different rare earths (or yttium), such as Nd₂Fe₁₄B/SmCo₅; Nd₂Fe₁₄B/Sm₂Co₁₇; Nd₂Fe₁₄B/Sm₂(Co,Fe)₁₇; (Pr,Nd)₂Fe₁₄B/Sm₂(Co,Fe)₁₇.

In addition, the nanocomposites can contain more than two compounds, such as Pr₂Fe₁₄B/PrCo₅/Gd₂(Co,Fe)₁₇; (Pr,Nd)₂Fe₁₄B/Sm₂(Co,Fe)₁₇/Er₂(Co,Fe)₁₇/Ho₂(Co,Fe)₁₇.

In these examples, each rare earth element can be further partially Substituted by other rare earths. Similarly, Co and Fe can be partially substituted by other transition metals.

The nanocomposite, rare earth permanent magnets of the present invention are made from at least two rare earth- or yttrium-transition metal compounds. Magnets made from each of the compounds alone would have different maximum operating temperatures. For example, a magnet made from one of the rare earth- or yttrium-transition metal compounds, such as Nd₂Fe₁₄B, would generally have a maximum operating temperature of less than about 120° C., typically less than about 100° C. A magnet made from the other rare earth- or yttrium-transition metal compound, such as Sm₂Co₁₇, would generally have a maximum operating temperature greater than about 250° C., typically greater than about 300° C., or greater than about 350° C., or greater than about 400° C., or greater than about 450° C., or greater than about 500° C.

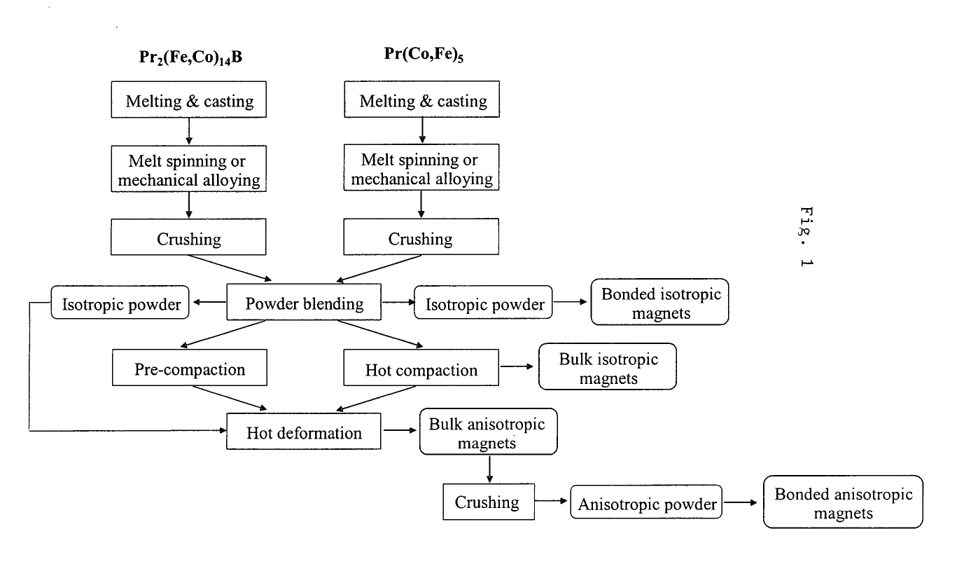

Examples of suitable processes for making the nanocomposite, rare earth permanent magnets of the present invention, such as Nd—Fe—B/Sm—Co, are shown in FIG. 1. The melting step can be performed in a vacuum induction furnace or a vacuum arc furnace, for example. The melt spinning step can be carried out using a melt spinner at a wheel surface linear speed of 20-50 m/sec or higher. For Nd₂Fe₁₄B based alloys, amorphous or partially crystallized alloys can be obtained in the as melt-spun ribbons. For Sm₂(Co,Fe)₁₇ based alloys, fine nanograin structure will be obtained directly after the melt spinning. Amorphous powders can also be obtained using high-energy mechanical alloying or high-energy milling. High-energy alloying or high-energy milling are especially useful for preparing Sm₂(Co,Fe)₁₇ type of materials which have relatively high melting temperatures.

At least two different powders, such as Nd₂Fe₁₄B powder and Sm₂(Co,Fe)₁₇ powder, are blended according to a specific ratio. The ratio of the alloys is generally in the range of about 90:10 to about 10:90. The ratio of the alloys depends on the properties of the alloys used, and the properties desired in the nanocomposite, rare earth permanent magnet. For example, the addition of a small amount (such as 10-20 wt %) of Sm₂(Co,Fe)₁₇ will provide a slight improvement in the thermal stability of Nd₂Fe₁₄B, while a greater improvement can be achieved by adding a larger amount (such as 30-50 wt %).

An optional step of blending a magnetically soft metal or alloy powder with the rare earth- or yttium-transition metal powders can be included, if desired. The magnetically soft metal or alloy can be Fe, Co, Fe—Co, Fe₃B, or other soft magnetic materials containing Fe, Co, or Ni. The magnetically soft metal or alloy can be included in an amount from about 2% up to about 15%. The powder particle size can be from a few nanometers to a few microns.

Instead of blending with a magnetically soft metal or alloy powder, an optional step of coating the rare earth- or yttrium-transition metal powders with a magnetically soft metal or alloy layer can be included either before or after the powder blending. Suitable powder coating methods include, but are not limited to, chemical coating (electroless coating), electrical coating, chemical vapor deposition, physical vapor deposition, sputtering, pulsed laser deposition, evaporation, and sol-gel process.

The powders are compacted to near full density or full density using a rapid hot press at a temperature in a range of about 500° C. to about 800° C. The process is very fast; the total time for heating from room temperature to the hot press temperature, completing the hot press, and cooling to about 200° C. is generally less than 10 minutes, typically about 0.5 to about 10 minutes, or about 1-4, or about 1-3 minutes. The pressure of the hot press is generally from about 10 kpsi (69 MPa) to about 40 kpsi (279 MPa). The rapid hot press process helps to minimize grain growth and interdiffusion effectively. After the rapid hot pressing, isotropic nanocomposite magnets, such as Nd₂Fe₁₄B/Sm₂(Co,Fe)₁₇, are obtained.

Alternatively, the hot press process can be replaced by a pre-compaction step performed at a temperature from about room temperature (about 20° C.) to a temperature less than the crystallization temperature of a corresponding amorphous alloy, which is generally about 500° C. to about 600° C. The pressure is generally in a range form about 10 kpsi (69 MPa) to about 40 kpsi (279 MPa). Pre-compaction can further prevent grain growth and interdiffusion.

In order to obtain high-performance anisotropic nanocomposite magnets, the hot pressed isotropic magnets or pre-compacted green bodies are further hot deformed. The hot deformation can be performed at about 700° C. to about 1050° C. for 2-10 minutes, typically 2-4 minutes at a pressure of from about 2 kpsi (14 MPa) to about 30 kpsi (207 MPa). In hot deformation, plastic flow takes place and crystallographic texture will be created. Experiments have indicated that good anisotropic magnets can be produced when the hot deformation amount (i.e., the height reduction after the hot deformation) is from about 60% to about 80%, desirably about 70%.

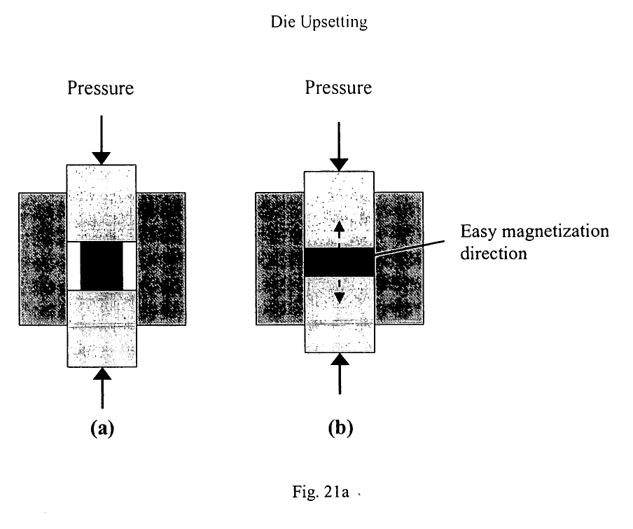

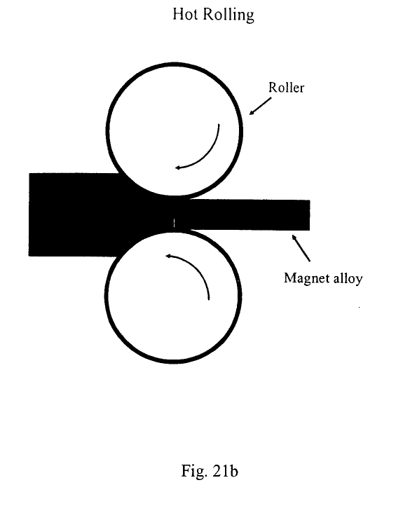

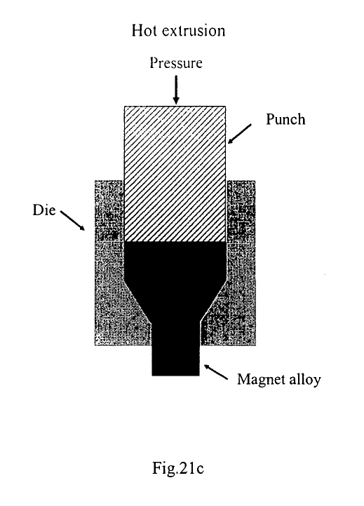

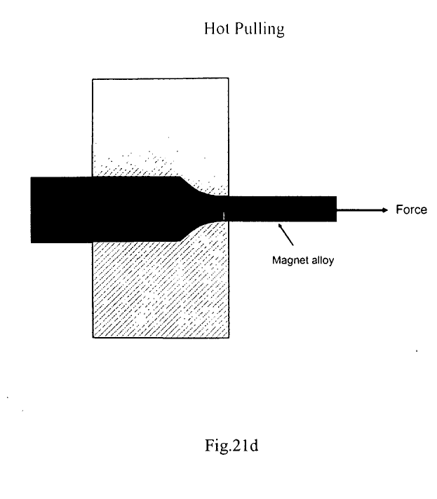

Suitable deformation processes include, but are not limited to, die upset, hot rolling, hot extrusion, and hot pulling, as shown in FIGS. 21a-d.

Alternatively, the hot press or pre-compaction step can be eliminated, and the blended powdered alloys can be hot deformed in a container directly to form the anisotropic nanocomposite magnets.

The hot press, pre-compaction, and hot deformation can be performed in vacuum, argon, or air.

Using the processes of the present invention, magnets having magnetic properties and temperature coefficient values in the range between the conventional Nd—Fe—B and Sm—Co magnets can be readily synthesized based on the specific application requirements by adjusting the blending ratio of the two materials. This will benefit many commercial and military applications where improved temperature coefficients of magnetic properties and/or higher operating temperatures are required.

Although not wishing to be bound by theory, it is believed that nanostructure brings about a fundamental change in coercivity mechanisms in rare earth permanent magnet materials. In conventional rare earth permanent magnets with micron grains, the coercivity is controlled by nucleation and/or pinning. In order to prevent nucleation of the reversed domains or to create appropriate pinning sites, composition modifications and/or special heat treatments or processing are often required.

In contrast, in rare earth permanent magnets with nanograins, the formation of multiple domains in a nanograin is no longer energetically favorable. Therefore, coercivity in magnets with nanograins is not controlled by nucleation or pinning, but is directly controlled by magneto-crystalline anisotropy. High uniaxial magneto-crystalline anisotropy is not only a necessary condition for high coercivity, as it is in magnets with micron grains, it is a sufficient condition for high coercivity in magnets with nanograins. Thus, it is believed that there is a direct connection between coercivity and magneto-crystalline anisotropy in magnets with nanogram structure. This means that it should be easy to obtain high coercivity in any materials that possess high uniaxial magneto-crystalline anisotropy if they have nanograin structure.

The nanocomposite, rare earth magnets of the present invention demonstrate high (BH)ₘₐₓ at room temperature and good coercivity. For example, a nanocomposite, isotropic rare earth magnet will generally have a (BH)ₘₐₓ at room temperature of at least about 10 MGOe, or at least about 12 MGOe, or at least about 14 MGOe. A nanocomposite, isotropic rare earth magnet will generally have a coercivity of at least about 8 KOe, or at least about 10 KOe, or at least about 15 KOe. A nanocomposite, anisotropic rare earth magnet will generally have a (BH)ₘₐₓ at room temperature of at least about 15 MGOe, or at least about 20 MGOe, or at least about 25 MGOe, while the coercivity will be at least about 8 KOe, or at least about 10 KOe, or at least about 12 KOe.

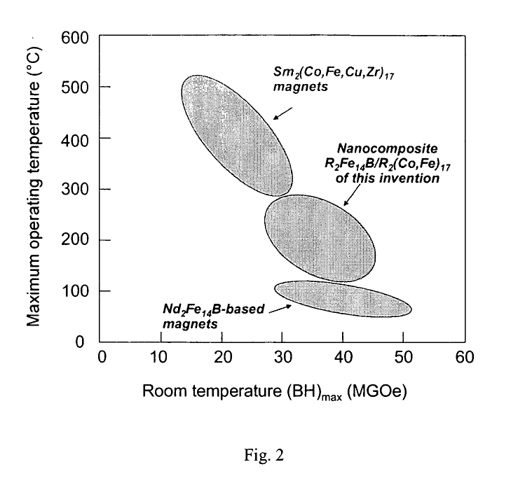

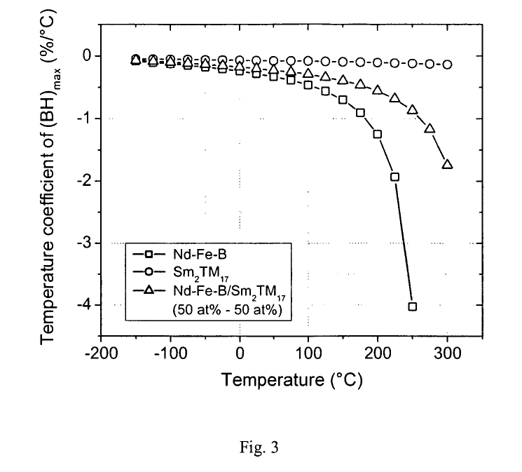

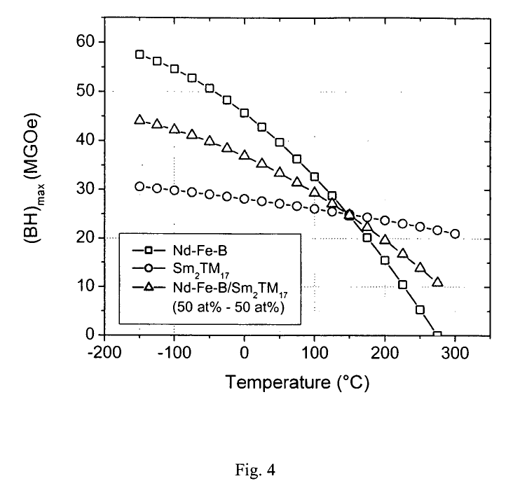

FIGS. 2-4 are graphs which illustrate the maximum operating temperature, temperature coefficient of (BH)ₘₐₓ and maximum energy product of nanocomposite Nd—Fe—B/Sm—Co magnets produced in accordance with the present invention compared with the performance of existing magnets.

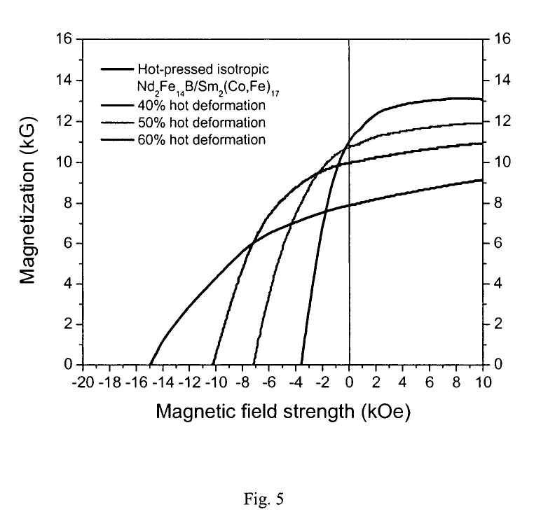

FIG. 5 illustrates the demagnetization curves of an isotropic Nd₂Fe₁₄B/Sm₂(Co,Fe)₁₇ magnet, 80 wt % of Nd₂Fe₁₄B+20 wt % of Sm₂(Co,Fe)₁₇ and denoted as [80 wt %/20 wt %], and an anisotropic Nd₂Fe₁₄B/Sm₂(Co,Fe)₁₇ magnet [80 wt %/20 wt %] with different hot deformation amounts.

In this figure, the isotropic nanocomposite magnet has a high intrinsic coercivity of 15 kOe and (BH)ₘₐₓ of 14 MGOe. The anisotropic nanocomposite magnet with 40% deformation has (BH)ₘₐₓ of 20 MGOe. It can be seen from FIG. 5 that by increasing the hot deformation amount, the magnetization is significantly increased, which suggests that anisotropic nanocomposite Nd₂Fe₁₄B/Sm₂(Co,Fe)₁₇ magnets can be readily obtained by hot deformation. While the intrinsic coercivity tends to decrease after the hot deformation, we have found that coercivity can be improved by optimizing the hot deformation parameters, for example by decreasing the hot deformation temperature and/or shortening the hot deformation time.

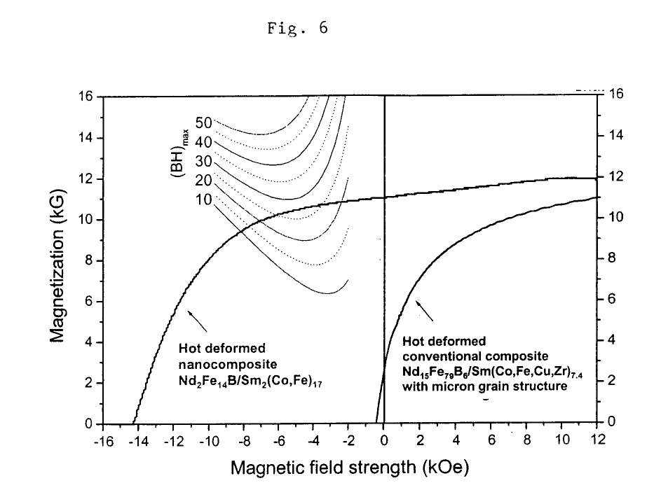

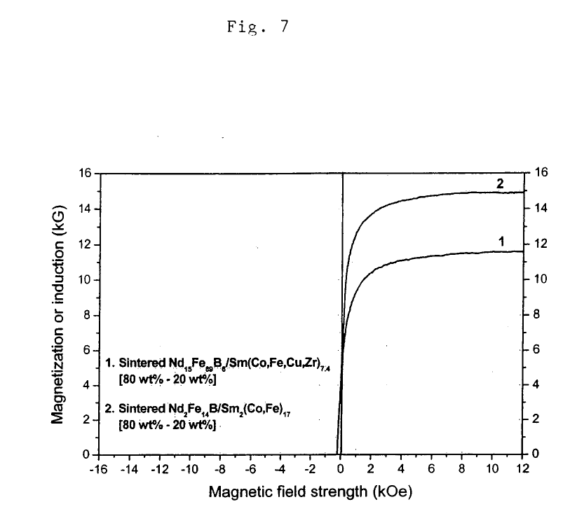

FIG. 6 illustrates demagnetization curves of a hot deformed nanocomposite Nd₁₄Fe_{74.5}Co₅Ga_{0.5}B₆/Sm_{7.7}Co_{63.7}Fe_{28.6} magnet and a hot deformed conventional composite Nd₁₅Fe₇₉B₆/Sm(Co,Fe,Cu,Zr)_{7.4} magnet with micron grain structure.

FIG. 7 illustrates demagnetization curves of a conventional sintered anisotropic Nd₁₅Fe₇₉B₆/Sm(Co,Fe,Cu,Zr)_{7.4} magnet and a conventional sintered anisotropic Nd₂Fe₁₄B/Sm₂(Co,Fe)₁₇ magnet.

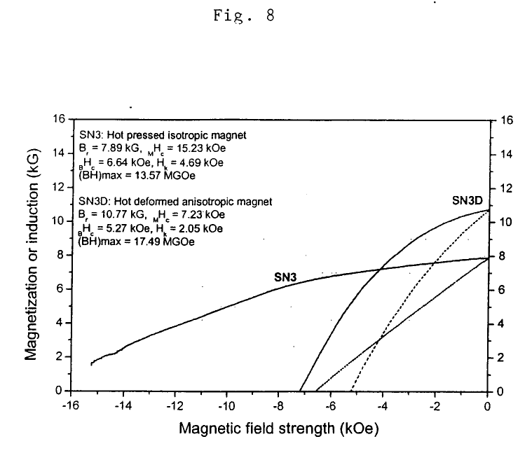

FIG. 8 shows demagnetization curves of a nanocomposite Nd₁₄Fe_{74.5}Co₅Ga_{0.5}B₆/Sm_{7.7}Co_{63.7}Fe_{28.6} [80 wt %/20 wt %] magnet after hot press at 575° C. and after hot deformation at 850° C. with 50% height reduction. The hot pressed isotropic magnet had a (BH)ₘₐₓ of 13.57 MGOe. The hot deformed anisotropic magnet had a (BH)ₘₐₓ of 17.49 MGOe.

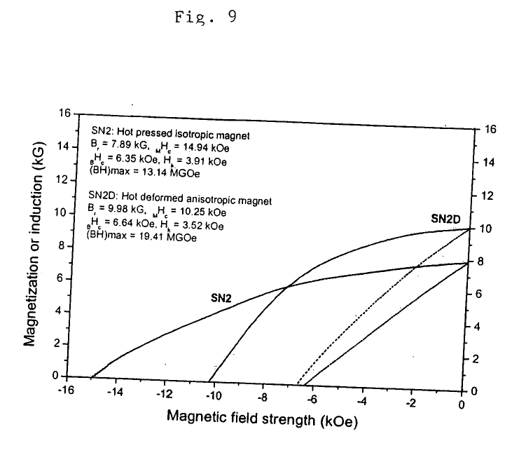

FIG. 9 shows demagnetization curves of a nanocomposite Nd₁₄Fe_{74.5}Co₅Ga_{0.5}B₆/Sm_{7.7}Co_{63.7}Fe_{28.6} [80 wt %/20 wt %] magnet after hot press at 600° C. and after hot deformation at 850° C. with 40% height reduction. The hot pressed isotropic magnet had a (BH)ₘₐₓ of 13.14 MGOe, and the hot deformed anisotropic magnet had a (BH)ₘₐₓ of 19.41 MGOe.

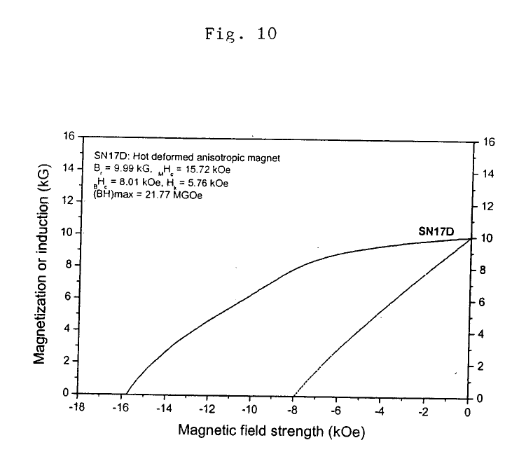

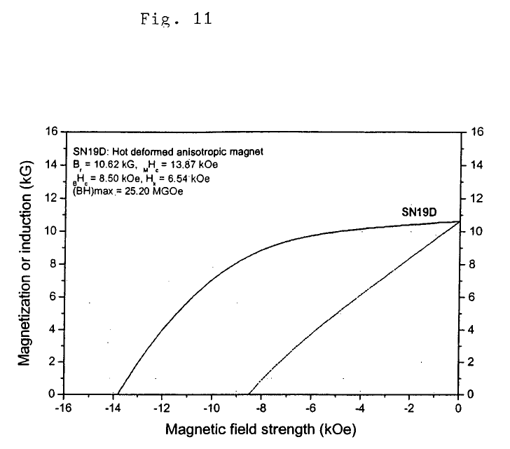

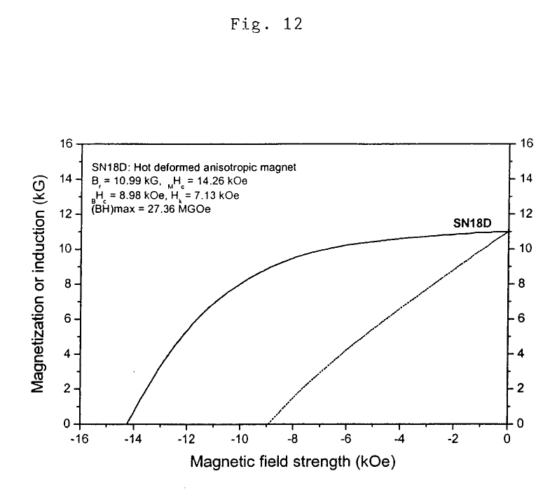

FIG. 10 is a graph illustrating demagnetization curves of an anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 880° C. with 60% height reduction. The magnet had a (BH)ₘₐₓ of 21.77 MGOe.

FIG. 11 is a graph illustrating demagnetization curves of an anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 920° C. with 60% height reduction. The magnet had a (BH)ₘₐₓ of 25.20 MGOe.

FIG. 12 illustrates the demagnetization curves of anisotropic nanocomposite Nd₁₄Fe_{74.5}Co₅Ga_{0.5}B₆/Sm_{7.7}Co_{63.7}Fe_{28.6} [80 wt %/20 wt %] magnet hot deformed at 880° C. with 60% height reduction. The (BH)ₘₐₓ of this magnet is 27.36 MGOe.

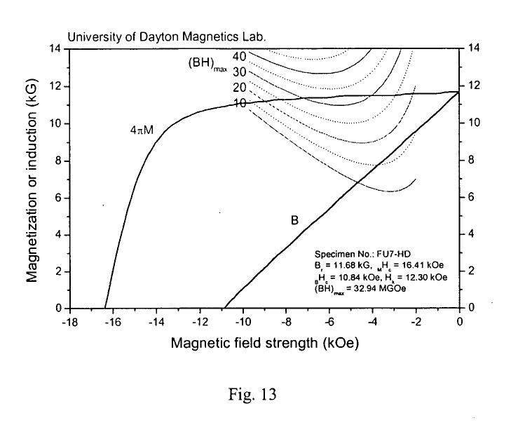

FIG. 13 shows demagnetization curves of an anisotropic nanocomposite Pr₁₄Fe_{73.5}Co₅Ga_{0.5}B₇/Pr_{16.7}Co_{83.3} [80 wt %/20 wt %] magnet hot deformed at 940° C. with 71% height reduction. The magnet had a (BH)ₘₐₓ of 32.94 MGOe.

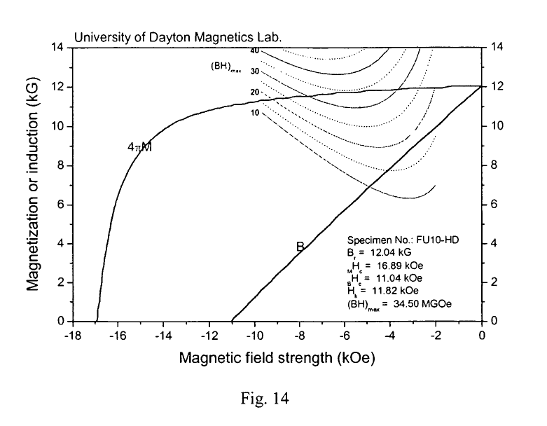

FIG. 14 shows demagnetization curves of an anisotropic nanocomposite Pr₁₄Fe_{73.5}Co₅Ga_{0.5}B₇/Pr_{16.7}Co_{66.6}Fe_{16.7} [80 wt %/20 wt %] magnet hot deformed at 920° C. with 71% height reduction. The magnet had a (BH)ₘₐₓ of 34.50 MGOe.

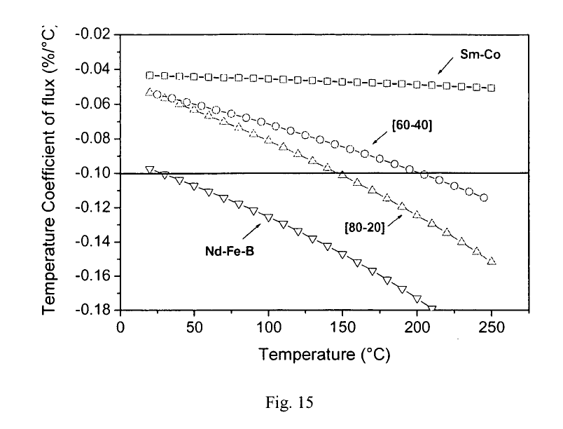

FIG. 15 shows temperature coefficients of magnetic flux v. temperature of nanograin Nd₁₄Fe_{74.5}Co₅Ga_{0.5}B₆, Sm_{7.7}Co_{63.7}Fe_{28.6} magnets and two nanocomposite Nd₁₄Fe_{74.5}Co₅Ga_{0.5}B₆/Sm_{7.7}Co_{63.7}Fe_{28.6} magnets.

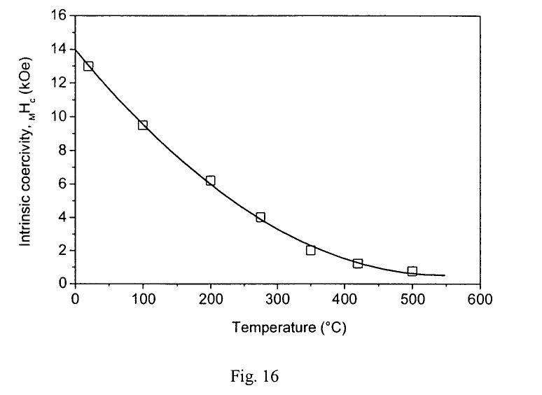

FIG. 16 shows the temperature dependence of intrinsic coercivity of nanocomposite Nd₁₄Fe_{74.5}Co₅Ga_{0.5}B₆/Sm_{7.7}Co_{63.7}Fe_{28.6} [60 wt %/40 wt %] magnet.

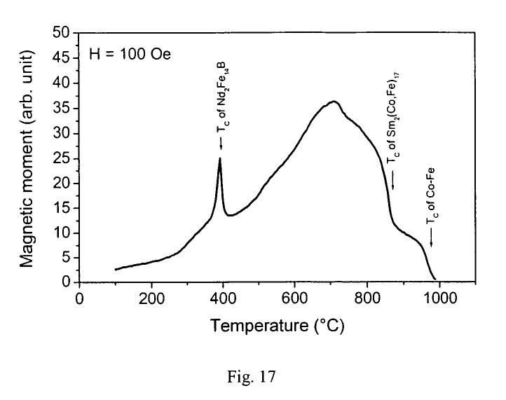

FIG. 17 shows the low field magnetization v. temperature for a nanocomposite Nd₁₄Fe_{74.5}Co₅Ga_{0.5}B₆/Sm_{7.7}Co_{63.7}Fe_{28.6} [80 wt %/20 wt %] magnet.

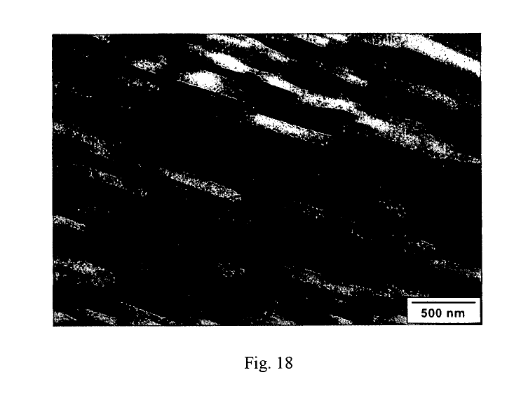

FIG. 18 is an SEM micrograph of fracture surface of a hot deformed Nd₁₄Fe_{74.5}Co₅Ga_{0.5}B₆/Sm_{7.7}Co_{63.7}Fe_{28.6} [80 wt %/20 wt %].

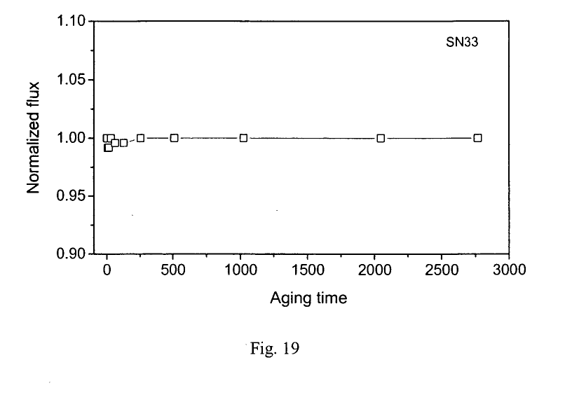

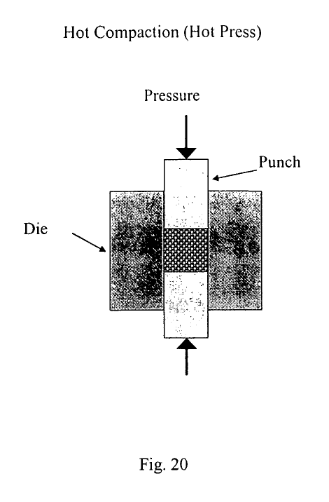

FIG. 19 shows the results of a long-term aging experiment of a nanocomposite Nd₁₄Fe_{74.5}Co₅Ga_{0.5}B₆/Sm_{7.7}Co_{63.7}Fe_{28.6} [80 wt %/20 wt %] magnet.

Table 1 illustrates a comparison of composite Nd—Fe—B/Sm—Co [80 wt %/20% wt] and Pr—Fe—B/Pr—Co magnets synthesized using different processes.

TABLE 1

| | 4 πM at | | | |
|---|---|---|---|---|
| | 10 kOe | Bᵣ | _{M}H_{c} | (BH)ₘₐₓ |
| Composite magnets | (kG) | (kG) | (kOe) | (MGOe) |
| Hot deformed | 10.71 | 2.54 | 0.39 | 0.24 |
| Nd₁₅Fe₇₉B₆/Sm(Co,Fe,Cu,Zr)_{7.4} | | | | |
| [80 wt %/20 wt %] | | | | |
| with micron grain structure | | | | |
| Sintered anisotropic | 11.59 | 5.35 | 0.20 | 0.32 |
| Nd₁₅Fe₇₉B₆/Sm(Co,Fe,Cu,Zr)_{7.4} | | | | |
| [80 wt %/20 wt %] | | | | |
| with micron grain structure | | | | |
| Sintered anisotropic | 15.01 | 2.67 | 0.10 | 0.01 |
| Nd₂Fe₁₄B/Sm₂(Co,Fe)₁₇ | | | | |
| [80 wt %/20 wt %] | | | | |
| with micron grain structure | | | | |
| Hot deformed nanocomposite | 11.91 | 10.99 | 14.26 | 27.36 |
| Nd₁₄Fe_{74.5}Co₅Ga_{0.5}B₆/ | | | | |
| Sm_{7.7}Co_{63.7}Fe_{28.6} | | | | |
| [80 wt %/20 wt %] | | | | |
| using process in this invention | | | | |
| Hot deformed nanocomposite | 11.98 | 11.68 | 16.41 | 32.94 |
| Pr₁₄Fe_{73.5}Co₅Ga_{0.5}B₇/ | | | | |
| Pr_{16.7}Co_{83.3} | | | | |
| [80 wt %/20 wt %] | | | | |
| using process in this invention | | | | |
| Hot deformed nanocomposite | 12.25 | 12.04 | 16.89 | 34.50 |
| Pr₁₄Fe_{73.5}Co₅Ga_{0.5}B₇/ | | | | |
| Pr_{16.7}Co_{66.6}Fe_{16.7} | | | | |
| [80 wt %/20 wt %] | | | | |
| using process in this invention | | | | |

While certain representative embodiments and details have been shown for purposes of illustrating the invention, it will be apparent to those skilled in the art that various changes in the compositions and methods disclosed herein may be made without departing from the scope of the invention, which is defined in the appended claims.

What is claimed is:

1. A nanocomposite, rare earth permanent magnet comprising at least two rare earth- or yttrium-transition metal compounds each of which is specified in atomic percentage as RₓT_{100-x-y}M_{y}, and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20, and wherein the at least two rare earth- or yttrium-transition metal compounds are of different types, or contain different R, or both, and wherein the nanocomposite, rare earth permanent magnet has a structure selected from isotropic or anisotropic, and wherein the nanocomposite, rare earth permanent magnet has an average grain size in a range of about 1 nm to about 1000 nm, and wherein the nanocomposite, rare earth permanent magnet has a maximum operating temperature in a range of from about 130° C. to about 300° C.

2. The nanocomposite, rare earth permanent magnet of claim 1 wherein the at least two rare earth- or yttrium-transition metal compounds have an atomic ratio of R:T or R:T:M selected from 1:5, 1:7, 2:17, 2:14:1, or 1:12.

3. The nanocomposite, rare earth permanent magnet of claim 1, wherein at least one of rare earth- or yttrium-transition metal compounds has the atomic ratio of 1:5, wherein x is between about 3 and about 18, and wherein y is between 0 and about 20.

4. The nanocomposite, rare earth permanent magnet of claim 1, wherein at least one of rare earth- or yttrium-transition metal compounds has the atomic ratio of 1:7, wherein x is between about 3 and about 14, and wherein y is between 0 and about 20.

5. The nanocomposite, rare earth permanent magnet of claim 1, wherein at least one of rare earth- or yttrium-transition metal compounds has the atomic ratio of 2:17, wherein x is between about 3 and about 12, and wherein y is between 0 and about 20.

6. The nanocomposite, rare earth permanent magnet of claim 1, wherein at least one of rare earth- or yttrium-transition metal compounds has the atomic ratio of 2:14:1, wherein x is between about 3 and about 15, and wherein y is between about 1 and about 20.

7. The nanocomposite, rare earth permanent magnet of claim 1, wherein at least one of rare earth- or yttrium-transition metal compounds has the atomic ratio of 1:12, wherein x is between about 3 and about 9, and wherein y is between about 0 and about 20.

8. The nanocomposite, rare earth permanent magnet of claim 1, wherein the rare earth is selected from Nd, Sm, Pr, Dy, La, Ce, Gd, Tb, Ho, Er, Eu, Tm, Yb, Lu, misch metal, or combinations thereof.

9. The nanocomposite, rare earth permanent magnet of claim 1, wherein T is selected from Fe, Co, Ni, Ti, Zr, Hf, V, Nb, Ta, Cr, Mo, W, Mn, Cu, Zn, Cd, or combinations thereof.

10. The nanocomposite, rare earth permanent magnet of claim 1 wherein M is selected from B, Al, Ga, In, Ti, C, Si, Ge, Sn, Sb, Bi, or combinations thereof.

11. The nanocomposite, rare earth permanent magnet of claim 1 wherein the intrinsic coercivity is greater than about 8 kOe (SI units).

12. The nanocomposite, rare earth permanent magnet of claim 1 wherein the intrinsic coercivity is greater than about 10 kOe (SI units).

13. The nanocomposite, rare earth permanent magnet of claim 1 wherein the (BH)ₘₐₓ at room temperature is greater than about 10 MGOe (SI units).

14. The nanocomposite, rare earth permanent magnet of claim 1 wherein the (BH)ₘₐₓ at room temperature of greater than about 15 MGOe (SI units).

15. The nanocomposite, rare earth permanent magnet of claim 1 wherein the nanocomposite, rare earth permanent magnet is a bulk, fully dense rare earth permanent magnet.

16. The nanocomposite, rare earth permanent magnet of claim 1 wherein the nanocomposite, rare earth permanent magnet is a bonded rare earth permanent magnet.

17. The nanocomposite, rare earth permanent magnet of claim 1 wherein the nanocomposite, rare earth permanent magnet is crushed to form a powder.

18. The nanocomposite, rare earth permanent magnet of claim 1 wherein a ratio of the at least two rare earth- or yttrium-transition metal compounds ranges from about 90:10 to about 90:10.

19. A method of making a nanocomposite, rare earth permanent magnet comprising at least two rare earth- or yttrium-transition metal compounds each of which is specified in atomic percentage as RₓT_{100-x-y}M_{y} and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20, and wherein the at least two rare earth- or yttrium-transition metal compounds are of different types, or contain different R, or both, and wherein the nanocomposite, rare earth permanent magnet has a structure selected from isotropic or anisotropic, and wherein the nanocomposite, rare earth permanent magnet has an average grain size in a range of about 1 nm to about 1000 nm, and wherein the nanocomposite, rare earth permanent magnet has a maximum operating temperature in a range of from about 130° C. to about 300° C., the method comprising:
providing at least two powdered rare earth- or yttrium-transition metal alloys wherein the rare earth- or yttrium-transition metal alloys comprise the rare earth- or yttrium-transition metal compounds;
blending the at least two powdered rare earth- or yttrium-transition metal alloys; and
hot pressing the at least two powdered rare earth- or yttrium-transition metal alloys to form the nanocomposite, isotropic rare earth permanent magnet.

20. The method of claim 19 wherein the blended powdered rare earth- or yttrium-transition metal alloys are hot pressed at a temperature in a range of 500° C. to 800° C.

21. The method of claim 19 wherein the blended powdered rare earth- or yttrium-transition metal alloys are hot pressed at a pressure in a range of 10 kpsi (69 MPa) to 40 kpsi (276 MPa).

22. The method of claim 19 wherein the blended powdered rare earth- or yttrium-transition metal alloys are hot pressed for a time in a range of 0.5 to 10 minutes.

23. The method of claim 19 wherein the blended powdered rare earth- or yttrium-transition metal alloys are hot pressed using induction heating.

24. The method of claim 19 wherein the blended powdered rare earth- or yttrium-transition metal alloys are hot pressed using a heat source selected from DC current, pulse DC current, AC current, or eddy-current, and wherein the current directly goes through the blended powdered rare earth- or yttrium-transition metal alloys.

25. The method of claim 19 wherein providing the at least two powdered rare earth- or yttrium-transition metal alloys comprises:
forming the rare earth- or yttrium-transition metal alloys; and
forming the powdered rare earth- or yttrium-transition metal alloys.

26. The method of claim 25 wherein the rare earth- or yttrium-transition metal alloys are formed by a method selected from melt-spinning, mechanical alloying, high energy mechanical milling, spark erosion, plasma spray, or atomization.

27. The method of claim 19 further comprising hot deforming the nanocomposite, isotropic rare earth permanent magnet to form the nanocomposite, anisotropic rare earth permanent magnet.

28. The method of claim 27 wherein the nanocomposite, isotropic rare earth permanent magnet is hot deformed at a temperature in a range of 700° C. to 1000° C.

29. The method of claim 27 wherein the nanocomposite, isotropic rare earth permanent magnet is hot deformed at a pressure in a range of 2 kpsi (14 MPa) to 30 kpsi (207 MPa).

30. The method of claim 27 wherein the nanocomposite, isotropic rare earth permanent magnet is hot deformed at a strain rate in a range of 10⁻⁴/second to 10⁻²/second.

31. The method of claim 27 wherein the nanocomposite, isotropic rare earth permanent magnet is hot deformed for a time of less than 10 minutes.

32. The method of claim 19 further comprising:
crushing the nanocomposite, anisotropic permanent magnet to form a powdered anisotropic material; and
mixing a binder with the powdered anisotropic material to form a bonded anisotropic permanent magnet.

33. The method of claim 19 further comprising blending a soft magnetic material containing Fe, Co, or Ni with the at least two powdered rare earth- or yttrium-transition metal alloys.

34. A method of making a nanocomposite, rare earth permanent magnet comprising at least two rare earth- or yttrium-transition metal compounds each of which is specified in atomic percentage as RₓT_{100-x-y}M_{y}, and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20, and wherein the at least two rare earth- or yttrium-transition metal compounds are of different types, or contain different R, or both, and wherein the nanocomposite, rare earth permanent magnet has a structure selected from isotropic or anisotropic, and wherein the nanocomposite, rare earth permanent magnet has an average grain size in a range of about 1 nm to about 1000 nm, and wherein the nanocomposite, rare earth permanent magnet has a maximum operating temperature in a range of from about 130° C. to about 300° C., the method comprising:
providing at least two powdered rare earth- or yttrium-transition metal alloys wherein the rare earth- or yttrium-transition metal alloys comprise the rare earth- or yttrium-transition metal compounds;
blending the at least two powdered rare earth- or yttrium-transition metal alloys;
compacting the blended rare earth- or yttrium-transition metal alloys at a temperature less than a crystallization temperature of a corresponding amorphous alloy to form a compact; and
hot deforming the compact to form the nanocomposite, anisotropic rare earth permanent magnet.

35. The method of claim 34 wherein the compact is hot deformed at a temperature in a range of 700° C. to 1000° C.

36. The method of claim 34 wherein the compact is hot deformed at a pressure in a range of 2 kpsi (14 MPa) to 30 kpsi (207 MPa).

37. The method of claim 34 wherein the compact is hot deformed at a strain rate in a range of 10⁻⁴/second to 10⁻²/second.

38. The method of claim 34 wherein the compact is hot deformed for a time of less than 10 minutes.

39. The method of claim 34 wherein the blended powdered rare earth- or yttrium-transition metal alloys are compacted at a temperature in a range of about 20° C. to less than about 600° C.

40. The method of claim 34 wherein a compacting pressure is in a range of 10 kpsi (69 MPa) to 40 kpsi (276 MPa).

41. The method of claim 34 wherein providing the at least two powdered rare earth- or yttrium-transition metal alloys comprises:
forming a rare earth- or yttrium-transition metal alloy; and
forming the powdered rare earth- or yttrium-transition metal alloy.

42. The method of claim 41 wherein the powdered rare earth- or yttrium-transition metal alloy is formed by a method selected from melt-spinning, mechanical alloying, high energy mechanical milling, spark erosion, plasma spray, or atomization.

43. The method of claim 34 further comprising:
crushing the nanocomposite, anisotropic permanent magnet to form a powdered anisotropic material; and
mixing a binder with the powdered anisotropic material to form a bonded anisotropic permanent magnet.

44. The method of claim 34 further comprising blending a soft magnetic material containing Fe, Co, or Ni with the at least two powdered rare earth- or yttrium-transition metal alloys.

45. A method of making a nanocomposite, rare earth permanent magnet comprising at least two rare earth- or yttrium-transition metal compounds each of which is specified in atomic percentage as RₓT_{100-x-y}M_{y}) and wherein R is selected from one or more rare earths, yttrium, or combinations thereof, wherein T is selected from one or more transition metals, wherein M is selected from one or more elements in groups IIIA, IVA, VA, and wherein x is between 3 and 18, and wherein y is between 0 and 20, and wherein the at least two rare earth- or yttrium-transition metal compounds are of different types, or contain different R, or both, and wherein the nanocomposite, rare earth permanent magnet has a structure selected from isotropic or anisotropic, and wherein the nanocomposite, rare earth permanent magnet has an average grain size in a range of about 1 nm to about 1000 nm, and wherein the nanocomposite, rare earth permanent magnet has a maximum operating temperature in a range of from about 130° C. to about 300° C., the method comprising:
providing at least two powdered rare earth- or yttrium-transition metal alloys wherein the rare earth- or yttrium-transition metal alloys comprise the rare earth- or yttrium-transition metal compounds;
blending the at least two powdered rare earth- or yttrium-transition metal alloys; and
hot deforming the blended alloys in a container to form the nanocomposite, anisotropic rare earth permanent magnet.

46. The method of claim 45 wherein the blended alloys are hot deformed at a temperature in a range of 700° C. to 1000° C.

47. The method of claim 45 wherein the blended alloys are hot deformed at a pressure in a range of 2 kpsi (14 MPa) to 30 kpsi (207 MPa).

48. The method of claim 45 wherein the blended alloys are hot deformed at a strain rate in a range of 10⁻⁴/second to 10⁻²/second.

49. The method of claim 45 wherein the blended alloys are hot deformed for a time of less than 10 minutes.

50. The method of claim 45 wherein providing the at least two powdered rare earth- or yttrium-transition metal alloys comprises:
forming a rare earth- or yttrium-transition metal alloy; and
forming the powdered rare earth- or yttrium-transition metal alloy.

51. The method of claim 50 wherein the powdered rare earth- or yttrium-transition metal alloy is formed by a method selected from melt-spinning, mechanical alloying, high energy mechanical milling, spark erosion, plasma spray, or atomization.

52. The method of claim 45 further comprising:
crushing the nanocomposite, anisotropic permanent magnet to form a powdered anisotropic material; and
mixing a binder with the powdered anisotropic material to form a bonded anisotropic permanent magnet.

53. The method of claim 45 further comprising blending a soft magnetic material containing Fe, Co, or Ni with the at least two powdered rare earth- or yttrium-transition metal alloys.
